(19) United States
(12) Patent Application Publication
(10) Pub. No.: US 2026/0039569 A1
(43) Pub. Date: Feb. 5, 2026

(54) EXTRACTING DEVICE, EXTRACTING METHOD AND EXTRACTING PROGRAM

(71) Applicant: NIPPON TELEGRAPH AND TELEPHONE CORPORATION, Tokyo (JP)

(72) Inventors: Akinori FURUTA, Tokyo (JP); Yuhei HAYASHI, Tokyo (JP); Atsushi SUTO, Tokyo (JP); Satomi INOUE, Tokyo (JP)

(73) Assignee: NIPPON TELEGRAPH AND TELEPHONE CORPORATION, Tokyo (JP)

(21) Appl. No.: 19/103,193

(22) PCT Filed: Aug. 18, 2022
(86) PCT No.: PCT/JP2022/031272

§ 371 Date: Feb. 11, 2025

(51) Int. Cl. H04L 43/02; H04L 69/22

(52) U.S. Cl. CPC H04L 43/02; H04L 69/22

(57) ABSTRACT

In an extraction device (10), a storage unit (14) stores positional information (14a) indicating a position of predetermined information included in an element forming a protocol stack of a packet in the element. A specifying unit (15b) specifies a protocol stack of a packet to be analyzed. An extraction unit (15c) extracts, from the packet, information at a position of the positional information (14a) for each element forming the specified protocol stack.

### TECHNICAL FIELD

The present invention relates to an extraction device, an extraction method, and an extraction program.

### BACKGROUND ART

To monitor networks and analyze traffic trends, xFlow is known as a technique for sampling traffic transferred on networks and executing aggregation and analysis (see Non Patent Literatures 1 to 4). In xFlow, xFlow packets are analyzed, and statistical information necessary for traffic visualization is output.

### CITATION LIST

### Non Patent Literature

Non Patent Literature 1: “RFC3954 Cisco Systems NetFlow Services Export Version 9”, October 2004
Non Patent Literature 2: “Bidirectional Flow Export Using IP Flow Information Export (IPFIX)”, RFC5103, 7011 to 7015 January 2008
Non Patent Literature 3: “sFlow Version 5”, [online], July 2004, [retrieved on Jul. 20, 2022], Internet <URL: https://sflow.org/sflow version 5.txt>
Non Patent Literature 4: “Information Elements for Data Link Layer Traffic Measurement”, IE315 (RFC7133), May 2014

### SUMMARY OF INVENTION

### Technical Problem

However, according to the related art, when a protocol was added, it was difficult to respond promptly to an output of statistical information necessary for traffic visualization. For example, in order to analyze xFlow packets and output statistical information necessary for visualization, development is necessary for each protocol stack, and it is difficult to respond to addition of a protocol early.

The present invention has been made in view of the foregoing circumstances, and an object of the present invention is to enable early response to an output of statistical information necessary for traffic visualization even when a protocol is added in xFlow.

### Solution to Problem

In order to solve the above-described problems and achieve the object, according to an aspect of the present invention, an extraction device includes: a storage unit configured to store positional information indicating a position of predetermined information included in an element forming a protocol stack of a packet in the element; a specifying unit configured to specify a protocol stack of a packet to be analyzed; and an extraction unit configured to extract, from the packet, information at a position of the positional information for each element forming the specified protocol stack.

### Advantageous Effects of Invention

According to the present invention, even when a protocol is added, in xFlow it is possible to respond to an output of statistical information necessary for traffic visualization early.

### BRIEF DESCRIPTION OF DRAWINGS

FIG. 1 is a diagram illustrating an overview of an extraction device.

FIG. 2 is a diagram illustrating an overview of the extraction device.

FIG. 3 is a schematic diagram illustrating a schematic configuration of the extraction device.

FIG. 4 is a diagram illustrating a process of a specifying unit.

FIG. 5 is a diagram illustrating a process of an extraction unit.

FIG. 6 is a diagram illustrating a process of a presentation unit.

FIG. 7 is a flowchart illustrating an extraction processing procedure.

FIG. 8 is a diagram illustrating an example of a computer that executes an extraction program.

### DESCRIPTION OF EMBODIMENTS

Hereinafter, an embodiment of the present invention will be described in detail with reference to the drawings. The present invention is not limited to the embodiment. In description of the drawings, the same portions are denoted by the same reference signs.

### Overview of Extraction Device

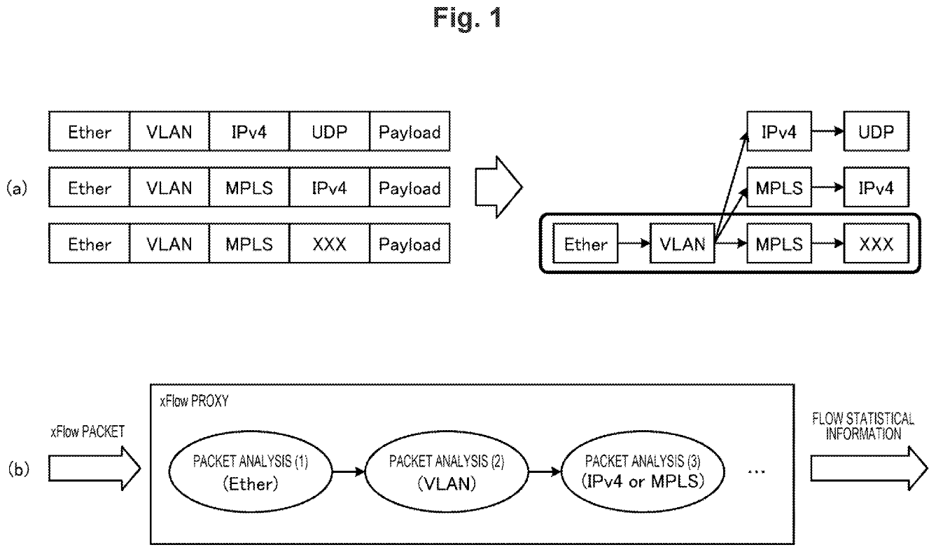

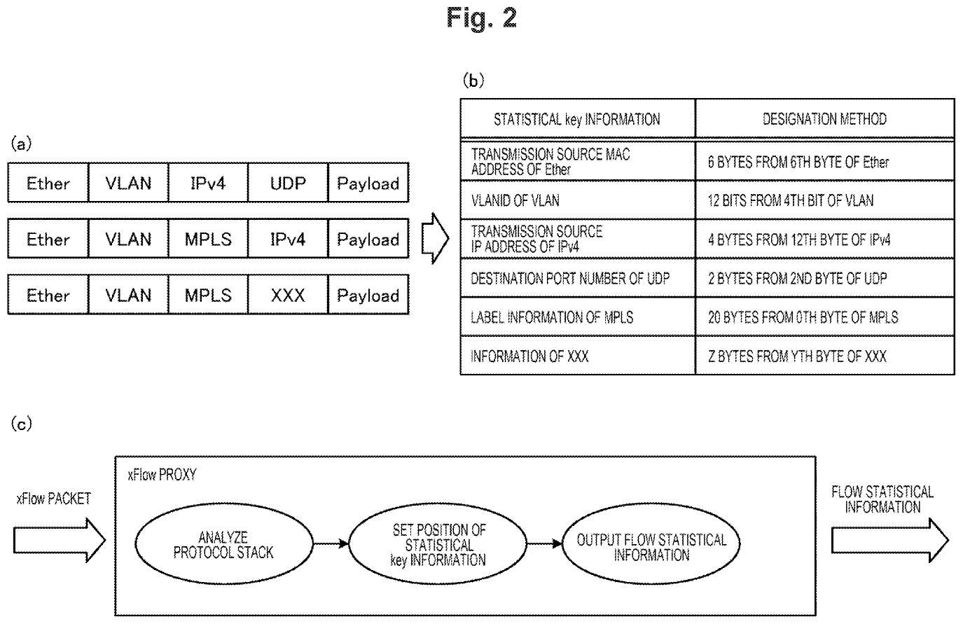

FIGS. 1 and 2 are diagrams illustrating an overview of an extraction device. The extraction device according to the embodiment extracts, from the xFlow packets to be analyzed, statistical information (hereinafter also referred to as statistical key information) such as a transmission source MAC address, a VLAN-ID, a transmission source IP address, and a destination port number necessary for traffic visualization.

Here, FIG. 1 illustrates a packet analysis scheme according to the related art. As illustrated in FIG. 1(a), a protocol stack including various protocols for each service is used for a packet to be analyzed. Then, as illustrated in FIG. 1(b), the packet analysis is executed through conditional branching from the head of an xFlow packet for each protocol stack. Therefore, for example, when packet analysis of a new protocol “xxx” is executed, it is necessary to execute hard-coding on the new protocol stack including “xxx” as surrounded by a thick frame in FIG. 1(a). Therefore, a development operation and a development period are required, and it is difficult to respond early.

On the other hand, FIG. 2 illustrates a packet analysis process by an extraction device according to the embodiment. The extraction device (xFlow proxy) according to the embodiment ascertains a configuration of a protocol stack as illustrated in FIG. 2(a), and sets positional information indicating a start position and a size of statistical key information extracted from a packet to be analyzed in advance for each protocol of elements included in the protocol stack as illustrated in FIG. 2(b). When the new protocol “xxx” is added, a location of the statistical key information to be extracted is set in the positional information of the protocol “xxx”.

Then, in the packet analysis, as illustrated in FIG. 2(c), the extraction device analyzes the protocol stack of the xFlow packet to be analyzed, ascertains the configuration of the protocol stack, and extracts information regarding the protocol at a position indicated by the preset positional information. Accordingly, even when a protocol is newly added, it is possible to respond to addition to an analysis target early simply by adding a location of the statistical information to be extracted to the positional information.

The extraction device outputs the extracted information as flow statistical information in accordance with a preset output item. It is possible to control information to be output as statistical information only by setting the information as the output item.

### Configuration of Extraction Device

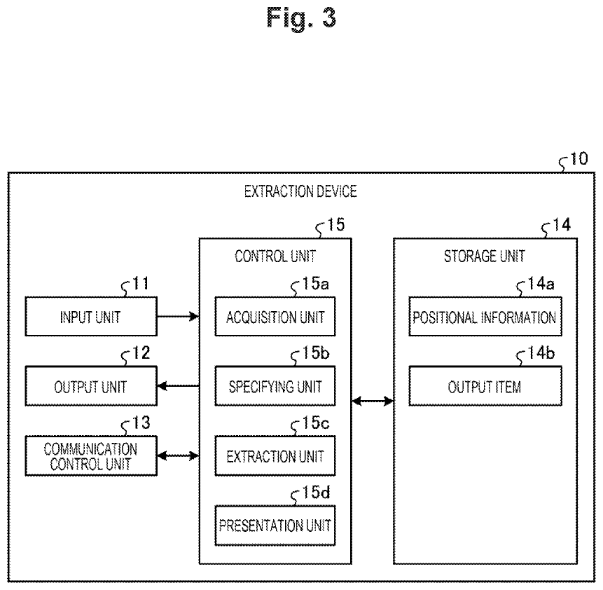

FIG. 3 is a schematic diagram illustrating a schematic configuration of the extraction device. As exemplified in FIG. 3, the extraction device 10 according to the embodiment is realized by a general-purpose computer such as a personal computer and includes an input unit 11, an output unit 12, a communication control unit 13, a storage unit 14, and a control unit 15.

The input unit 11 is realized using an input device such as a keyboard or a mouse and inputs various types of instruction information such as processing start to the control unit 15 in response to an input operation of an operator. The output unit 12 is realized with a display device such as a liquid crystal display, a printing device such as a printer, or the like. For example, the output unit 12 displays a result of an extraction process to be described below.

The communication control unit 13 is realized with a network interface card (NIC) or the like, and controls communication between the control unit 15 and an external device via a telecommunication line such as a local area network (LAN) or the Internet. For example, the communication control unit 13 controls communication between the control unit 15 and another network device or the like.

The storage unit 14 is realized with a semiconductor memory element such as a random access memory (RAM) or a flash memory, or a storage device such as a hard disk or an optical disc. In the storage unit 14, a processing program operating the extraction device 10, data used during execution of the processing program, and the like are stored in advance, or temporarily stored whenever a process is executed. The storage unit 14 may have a configuration for communication with the control unit 15 via the communication control unit 13. In the embodiment, the storage unit 14 stores positional information 14a and an output item 14b used for an extraction process to be described later.

The control unit 15 is realized with a central processing unit (CPU) or the like and executes a processing program stored in a memory. Accordingly, as exemplified in FIG. 3, the control unit 15 functions as an acquisition unit 15a, a specifying unit 15b, an extraction unit 15c, and a presentation unit 15d. Each or some of these functional units may be implemented in different hardware. For example, the acquisition unit 15a may be implemented as a device different from other functional units. The control unit 15 may also include other functional units.

The acquisition unit 15a acquires a packet to be analyzed. For example, the acquisition unit 15a acquires an xFlow packet to be analyzed from a network device or the like via the input unit 11 or the communication control unit 13.

The acquisition unit 15a may store the acquired packet to be analyzed in the storage unit 14 earlier than the extraction process to be described below.

Alternatively, the acquisition unit 15a may immediately transfer the information to the specifying unit 15b to be described below without storing the information in the storage unit 14.

The specifying unit 15b specifies a protocol stack of a packet to be analyzed. Here, the protocol stack includes a plurality of protocols such as Ether, VLAN, IPv4, and UDP as elements and is expressed in a combination of these protocols. Specifically, the specifying unit 15b specifies the protocol stack by permutation of elements forming the protocol stack.

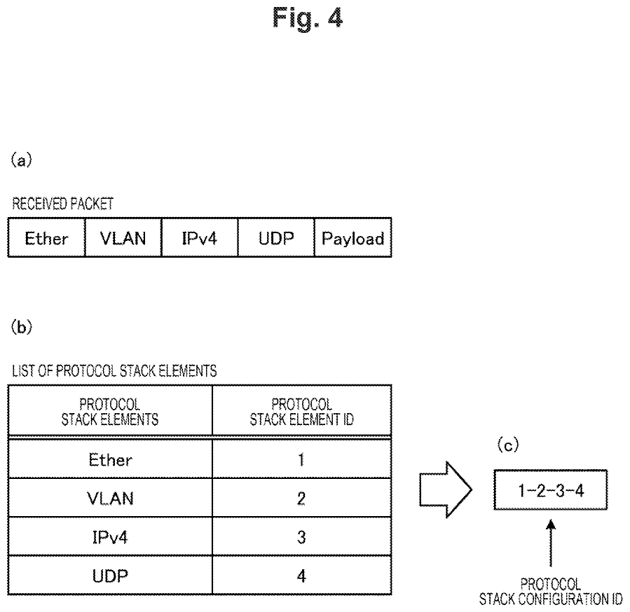

Here, FIG. 4 is a diagram illustrating a process of the specifying unit. As illustrated in FIG. 4(a), the specifying unit 15b specifies protocols such as Ether, VLAN, IPv4, and UDP and permutations of the elements with reference to header information and the like of a packet to be analyzed. The specifying unit 15b assigns a protocol stack configuration ID for identifying the specified protocol stack as illustrated in FIG. 4(c) by using the protocol stack element ID for identifying each protocol exemplified in FIG. 4(b). In the example illustrated in FIG. 4(c), the protocol stack configuration ID is specified by permutation of the protocol stack element IDs.

The information for identifying the protocol stack is not limited to the protocol stack configuration ID. For example, each protocol stack may be identified with a unique protocol stack name instead of or in addition to the protocol stack configuration ID.

FIG. 3 is referred to back for description. The extraction unit 15c extracts information at the position of the positional information 14a for each element forming the specified protocol stack from the packet. Here, as illustrated in FIG. 2(b), the positional information 14a is information indicating the position of predetermined statistical key information included in an element forming the protocol stack of the packet in the element. Specifically, the positional information 14a indicates a start position and a size of the predetermined statistics key information in the element of the protocol stack, and is preset. For example, the extraction unit 15c extracts information of the start position and the size designated by the positional information 14a as predetermined statistical key information from the header of the protocol which is an element of the protocol stack.

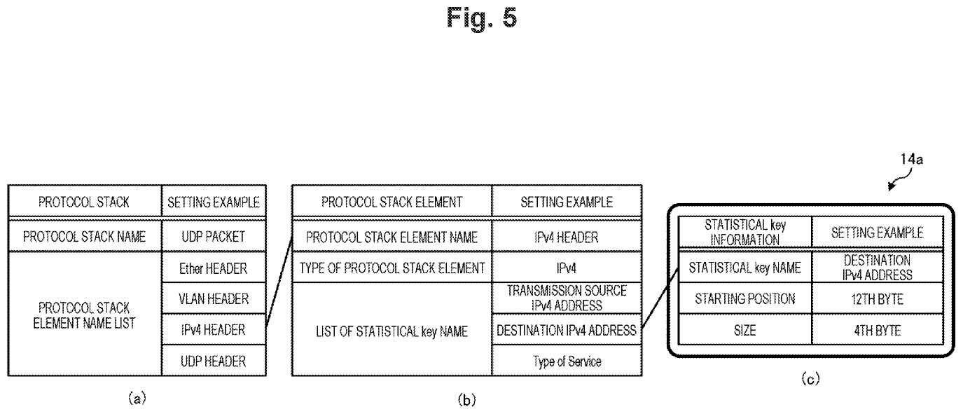

Here, FIG. 5 is a diagram illustrating a process of the extraction unit. FIG. 5 illustrates a method of setting the positional information 14a. The extraction unit 15c extracts the statistical key information illustrated in FIG. 5(b) from the header of the protocol which is a component of the protocol stack illustrated in FIG. 5(a). Therefore, the extraction unit 15c extracts information at the position designated by the positional information 14a illustrated in FIG. 5(c) as predetermined statistical key information.

FIG. 5 illustrates a case where the statistical key information “destination IPv4 address” is extracted from the “IPv4 header” among the protocols of the elements of the protocol stack “UDP packet”. Further, in the positional information 14a illustrated in FIG. 5(c), it is designated to extract 4 bytes of information from the 12th byte of the “IPv4 header” as the “destination IPv4 address”.

That is, in a case where a new protocol is added, by setting the position and size of predetermined statistical key information on the header of the protocol in the positional information 14a, the protocol can be added to the analysis target early.

FIG. 3 is referred to back for description. The presentation unit 15d presents information at the position of the extracted positional information 14a as information regarding a predetermined item for each protocol stack. For example, the presentation unit 15d outputs information designated by the output item 14b set in advance for each protocol stack as flow statistical information.

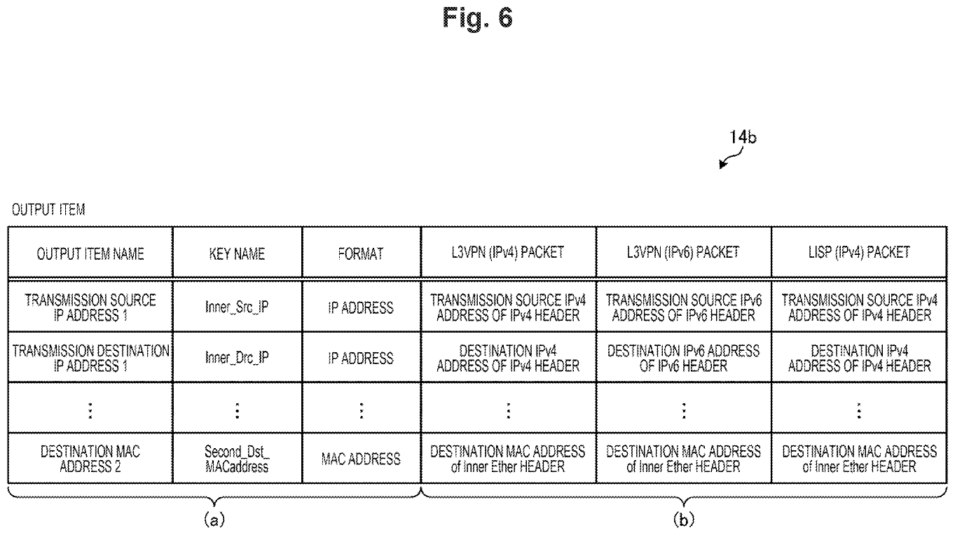

Here, FIG. 6 is a diagram illustrating a process of the presentation unit. FIG. 6 illustrates a setting example of the output item 14b. As illustrated in FIG. 6(a), the output item 14b designates an output item name, a key name, and a format in information to be output as the flow statistical information. In the output item 14b, as illustrated in FIG. 6(b), information to be output is designated for each protocol stack. In the example illustrated in FIG. 6, for example, in the protocol stack “L3VPN (IPv4) packet”, it is designated to output a transmission source IPv4 address of an extracted IPV4 header as an output item name “transmission source IP address 1”.

In this way, the extraction device 10 can store the extracted statistical key information in a hash table and control an item to be output as the flow statistical information.

### Extraction Process

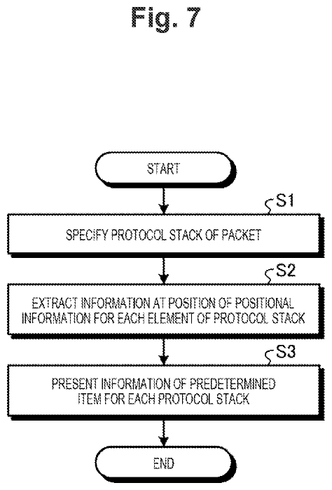

Next, an extraction process by the extraction device 10 according to the embodiment will be described with reference to FIG. 7. FIG. 7 is a flowchart illustrating an extraction processing procedure. The flowchart of FIG. 7 is started, for example, at a timing at which the user executes an input operation of starting an input instruction.

First, the acquisition unit 15a acquires a packet to be analyzed. The specifying unit 15b specifies a protocol stack of a packet to be analyzed (step S1). For example, the specifying unit 15b specifies the protocol stack by permutation of elements forming the protocol stack.

Subsequently, the extraction unit 15c extracts information at the position of the positional information 14a for each element forming the specified protocol stack from the packet (step S2). For example, the extraction unit 15c extracts the statistical key information of the start position and the size specified by the preset positional information 14a from the header of the protocol that is an element of the protocol stack.

The presentation unit 15d presents the statistical key information at the position of the extracted positional information 14a as information of a predetermined item for each protocol stack (step S3). For example, the presentation unit 15d outputs information designated by the output item 14b set in advance for each protocol stack as flow statistical information. Accordingly, a series of extraction processes ends.

### Effects

As described above, in the extraction device 10 according to the embodiment, the storage unit 14 stores the positional information 14a indicating a position of the predetermined information included in the element forming the protocol stack of the packet in the element. The specifying unit 15b specifies a protocol stack of a packet to be analyzed. The extraction unit 15c extracts information at the position of the positional information 14a for each element forming the specified protocol stack from the packet.

Specifically, the specifying unit 15b specifies the protocol stack by permutation of elements forming the protocol stack. The positional information 14a indicates the start position and the size of the predetermined information in the element of the protocol stack.

Accordingly, for example, when a new protocol is added, the start position and the size of the information extracted as the information on the protocol may be set in the positional information 14a. In this way, by generalizing the statistical information to be output using the positional information 14a, it is possible to respond early while inhibiting the development operation and the development period. Accordingly, the extraction device 10 can respond to an output of statistical information necessary for traffic visualization early even when the protocol is added in xFlow.

The presentation unit 15d presents information at the position of the extracted positional information 14a as information of a predetermined item for each protocol stack. Accordingly, it possible to easily control information to be output as the flow statistical information.

### Program

It is also possible to generate a program in which a process executed by the extraction device 10 according to the above embodiment is described in a computer executable language. As an embodiment, the extraction device 10 can be implemented by causing a desired computer to install an extraction program executing the foregoing extraction process as package software or online software. For example, by causing an information processing device to execute the foregoing extraction program, it is possible to cause the information processing device to function as the extraction device 10. The information processing device described here includes a desktop or notebook type personal computer. In addition, examples of the information processing device include mobile communication terminals such as a smartphone, a mobile phone, and a personal handyphone system (PHS), and slate terminals such as a personal digital assistant (PDA). The function of the extraction device 10 may be implemented in a cloud server.

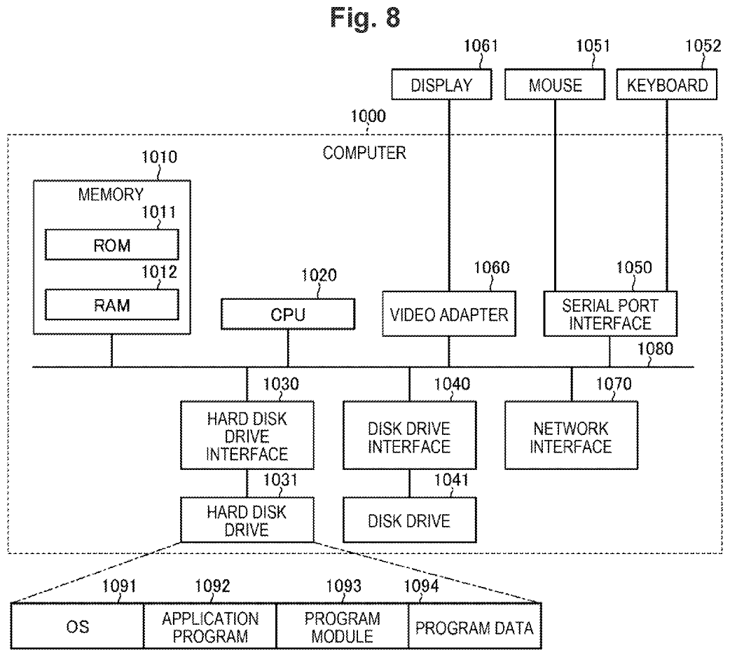

FIG. 8 is a diagram illustrating an example of a computer that executes an extraction program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected to, for example, a display 1061.

The hard disk drive 1031 stores, for example, an OS 1091, an application program 1092, a program module 1093, and program data 1094. Each piece of information described in the embodiment is stored in the hard disk drive 1031 or the memory 1010, for example.

For example, the extraction program is stored in the hard disk drive 1031 as the program module 1093 in which a command to be executed by the computer 1000 is described. Specifically, the program module 1093 in which each process executed by the extraction device 10 described in the foregoing embodiment is described is stored in the hard disk drive 1031.

Data used for information processing by the extraction program is stored, for example, in the hard disk drive 1031 as the program data 1094. The CPU 1020 reads the program module 1093 and the program data 1094 stored in the hard disk drive 1031 to the RAM 1012 as necessary and executes each procedure described above.

The program module 1093 and the program data 1094 related to the extraction program are not limited to being stored in the hard disk drive 1031 and may be stored in, for example, a removable storage medium and read by the CPU 1020 via the disk drive 1041 or the like. Alternatively, the program module 1093 and the program data 1094 related to the extraction program may be stored in another computer connected via a network such as a LAN or a wide area network (WAN) and read by the CPU 1020 via the network interface 1070.

Although the embodiment to which the invention made by the present inventor is applied has been described above, the present invention is not limited by the description and drawings forming parts of the disclosure of the present invention according to the embodiments. That is, other embodiments, examples, operation techniques, and the like made by those skilled in the art on the basis of the embodiment are all included in the scope of the present invention.

### REFERENCE SIGNS LIST

10 Extraction device
11 Input unit
12 Output unit
13 Communication control unit
14 Storage unit
14a Positional information
14b Output item
15 Control unit
15a Acquisition unit
15b Specifying unit
15c Extraction unit
15d Presentation unit

1. An extraction device comprising:
a storage unit configured to store positional information indicating a position of predetermined information included in an element forming a protocol stack of a packet in the element;
a specifying unit configured to specify a protocol stack of a packet to be analyzed; and
an extraction unit configured to extract, from the packet, information at a position of the positional information for each element forming the specified protocol stack.

2. The extraction device according to claim 1, wherein the specifying unit specifies the protocol stack by permutation of the elements.

3. The extraction device according to claim 1, wherein the positional information indicates a start position and a size of the predetermined information in the element.

4. The extraction device according to claim 1, further comprising a presentation unit configured to present information at a position of the extracted positional information as information regarding a predetermined item for each of the protocol stacks.

5. An extraction method executed by an extraction device including a storage unit that stores positional information indicating a position of predetermined information included in an element forming a protocol stack of a packet in the element, the method comprising:
specifying a protocol stack of a packet to be analyzed; and
extracting, from the packet, information at a position of the positional information for each element forming the specified protocol stack.

6. A computer-readable non-transitory recording medium storing computer-executable program instructions that when executed by a processor cause a computer to execute an extraction program, with reference to a storage unit that stores positional information indicating a position of predetermined information included in an element forming a protocol stack of a packet in the element, the extraction program comprising:
specifying a protocol stack of a packet to be analyzed; and
extracting, from the packet, information at a position of the positional information for each element forming the specified protocol stack.

7. The extraction device according to claim 1, wherein the extraction unit further extracts a predetermined statistical key information from a header of an element of a protocol stack.

8. The extraction method according to claim 5, wherein the protocol stack is specified by permutation of the elements.

9. The extraction method according to claim 5, wherein the positional information indicates a start position and a size of the predetermined information in the element.

10. The extraction method according to claim 5, further comprising presenting information at a position of the extracted positional information as information regarding a predetermined item for each of the protocol stacks.

11. The extraction method according to claim 5, wherein a predetermined statistical key information is extracted from a header of an element of a protocol stack.

12. The computer-readable non-transitory recording medium according to claim 6, wherein the protocol stack is specified by permutation of the elements.

13. The computer-readable non-transitory recording medium according to claim 6, wherein the positional information indicates a start position and a size of the predetermined information in the element.

14. The computer-readable non-transitory recording medium according to claim 6, further comprising presenting information at a position of the extracted positional information as information regarding a predetermined item for each of the protocol stacks.

15. The computer-readable non-transitory recording medium according to claim 6, wherein a predetermined statistical key information is extracted from a header of an element of a protocol stack.
